(19) United States
(12) Patent Application Publication
(10) Pub. No.: US 2023/0305745 A1
(43) Pub. Date: Sep. 28, 2023

(54) IDENTIFICATION AND TOLERANCE OF HOST ERRORS RELATED TO COMMAND PROTOCOLS IN NON-VOLATILE MEMORY DEVICES

(71) Applicant: Kioxia Corporation, Tokyo (JP)

(72) Inventors: Nigel Horspool, Abingdon (GB); Steve Wells, San Jose, CA (US); Neil Buxton, Berkshire (GB)

(73) Assignee: Kioxia Corporation, Tokyo (JP)

(21) Appl. No.: 17/700,651

(22) Filed: Mar. 22, 2022

(51) Int. Cl. G06F 3/06

(52) U.S. Cl. CPC G06F 3/0659; G06F 3/064; G06F 3/0635; G06F 3/0619; G06F 3/0679

(57) ABSTRACT

Various implementations described herein relate to systems, methods, and non-transitory computer-readable media for managing write commands to superblocks, including receiving, by a storage device from a host, a write command and a write data. The write command indicates that the write data is to be written to a first superblock of the storage device. The storage device determines the first superblock lacks sufficient capacity to store the write data. In response to determining that the first superblock lacks the sufficient capacity to store the write data, the storage device programs the write data to at least one of a reserved capacity of the first superblock or a second superblock.

### TECHNICAL FIELD

The present disclosure relates generally to non-volatile memory storage device such as Solid State Drives (SSDs), and in particular, to identifying and tolerating host errors related to command protocols in non-volatile memory storage devices.

### BACKGROUND

A non-volatile memory storage device such as Solid State Drive (SSD) may include superblock structures each created by arranging physical blocks from different dies (e.g., NAND dies) or different planes of the dies as a single structure to support redundancy and protection against one or more of the constituent blocks failing. Such a superblock is commonly referred to as a Redundant Arrays of Independent Disk (RAID) structure as the constituent blocks share similarities with redundancy techniques (e.g., RAID5 or RAID6). Superblocks may be commonly used for enterprise and datacenter implementations, as well as in multi-tenant environments.

Reclaiming a superblock for reuse involves garbage collecting the contents in the superblock and erasing the whole superblock. Therefore, for a new class of protocols that attempt to minimize the Write Amplification (WA) of user data, the ability to organize data in a way that is cognizant of the superblocks is advantageous. If the data set is aligned to the superblock and completely within the boundary of the superblock, the data set can be written and then trimmed with a WA Factor (WAF) of one by definition.

To help in aligning data from the host, the host “closes” the superblock, implicitly or explicitly, when the host is finished with the data set for that superblock and before writing more data to the superblock than the capacity of the superblock. “Closing” a superblock refers to refraining from writing additional data to the superblock. Conventionally, the host writing data exceeding the declared capacity of the superblock results in a write error.

Write errors are difficult to deal with, hence, there is a need to address the issue of the host writing more data to a superblock than the capacity of the superblock.

### SUMMARY

Some arrangements relate to systems, methods, and non-transitory computer-readable media comprising computer-readable instructions for managing write commands to superblocks, including receiving, by a storage device from a host, a write command and a write data. The write command indicates that the write data is to be written to a first superblock of the storage device. The storage device determines the first superblock lacks sufficient capacity to store the write data.

In response to determining that the first superblock lacks the sufficient capacity to store the write data, the storage device programs the write data to at least one of a reserved capacity of the first superblock or a second superblock. Feedback for the host write commands which result in writing more data than the declared capacity can be made via asynchronous mechanisms such as a log.

### BRIEF DESCRIPTION OF THE FIGURES

FIG. 1 shows a block diagram of an example storage device, according to some arrangements.

FIG. 2 is a schematic diagram illustrating superblock formation.

FIG. 3 is a schematic diagram illustrating write management for superblocks, according to various arrangements.

FIG. 4 is a method for identifying and tolerating host errors in which the host attempts to write data that exceeds the declared capacity of a superblock, according to various arrangements.

### DETAILED DESCRIPTION

Non-volatile storage media in a storage device (e.g., an SSD) can be arranged into superblock structures for providing Error Correction Code (ECC) and redundancy protection (e.g., RAID). As referred to herein, a superblock structure refers to a plurality of blocks grouped together with redundancy protection and ECC among those blocks. The grouping, the redundancy protection, and ECC are implemented by a controller, for example, on its firmware or software. If one block in a superblock fails, then the data stored in the failed block can be recovered using data stored on other blocks of the superblock based on ECC (e.g., RAID).

One approach to address a multi-tenant environment is streams, sometimes referred to as Multi-Stream Write (MSW). In this solution, the host identifies a tenant number as part of the write commands. The SSD then creates independent superblocks for each write stream. The data associated with each tenant is more likely to share common characteristics such as data lifetime, write, overwrite, and trim behavior, compared to independent tenants, thus creating less overall garbage collection and improved WA. In the streams solution, the drive separates tenant writes to separate superblocks to reduce garbage collection. The garbage collection process remains fully orchestrated by the SSD, and the host is not involved.

An SSD starts its life with a number of initial bad blocks as manufactured. During the lifetime of the SSD, various types of stress induce additional grown bad blocks. Moreover, a part of a die (e.g., whole planes of the die) or a whole die may fail, thus creating a large number of grown bad blocks.

SSDs for the enterprise and datacenter markets typically arrange physical blocks from different NAND die to create a larger superblock structures to support redundancy and to protect against any one or more of the constituent blocks of the superblock failing. A total size or capacity of the superblock typically may include the declared capacity and additional, reserved blocks (referred herein as reserved capacity) to replace any grown bad blocks in the declared capacity. That is, a superblock may be defined with a reserved capacity to cope with bad blocks. Hence, the reserved capacity may correspond to additional memory space that is initially unused until the superblock grows bad blocks.

The present arrangements relate to a non-volatile storage device (e.g., an SSD) tolerating a host breaking modern datacenter command protocols and identifying error conditions. For example, the non-volatile storage device reports to the host in response to determining that more data has been written to a superblock than the declared superblock capacity and writes the data to another superblock. In other words, instead of reporting an error condition to the host and rejecting write commands for overflow data as conventionally performed, the non-volatile storage device tolerates such error condition.

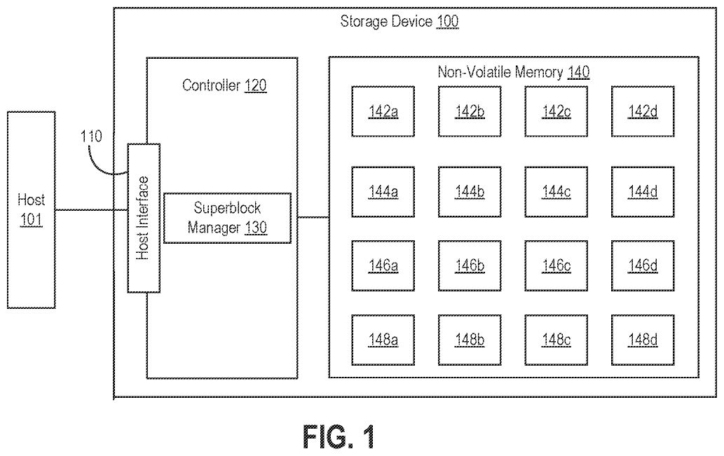

To assist in illustrating the present implementations, FIG. 1 shows a block diagram of a system including a storage device 100 coupled to a host 101 according to some implementations. In some examples, the host 101 can be a user device operated by a user. The host 101 may include an Operating System (OS), which is configured to provide a file system and applications that use the file system. The file system communicates with the storage device 100 (e.g., a controller 120 of the storage device 100) over a suitable wired or wireless communication link or network to manage storage of data in the storage device 100.

In that regard, the file system of the host 101 sends data to and receives data from the storage device 100 using a suitable host interface 110 of the storage device 100. The host interface 110 allows the software (e.g., the file system) of the host 101 to communicate with the storage device 100 (e.g., the controller 120). While the host interface 110 is conceptually shown as a block between the host 101 and the storage device 100, the host interface 110 can include one or more controllers, one or more namespaces, ports, transport mechanisms, and connectivity thereof. To send and receive data, the software or file system of the host 101 communicates with the storage device 100 using a storage data transfer protocol running on the host interface 110. Examples of the protocol include but are not limited to, the Serial Attached Small Computer System Interface (SAS), Serial AT Attachment (SATA), and Non-Volatile Memory Express (NVMe) protocols. The host interface 110 includes hardware (e.g., controllers) implemented on the host 101, the storage device 100 (e.g., the controller 120), or another device operatively coupled to the host 101 and/or the storage device 100 via one or more suitable networks. The host interface 110 and the storage protocol running thereon also includes software and/or firmware executed on the hardware.

In some examples, the storage device 100 is located in a datacenter (not shown for brevity). The datacenter may include one or more platforms, each of which supports one or more storage devices (such as but not limited to, the storage device 100). In some implementations, the storage devices within a platform are connected to a Top of Rack (TOR) switch and can communicate with each other via the TOR switch or another suitable intra-platform communication mechanism. In some implementations, at least one router may facilitate communications among the storage devices in different platforms, racks, or cabinets via a suitable networking fabric. Examples of the storage device 100 include non-volatile devices such as but are not limited to, an SSD, a Non-Volatile Dual In-line Memory Module (NVDIMM), a Universal Flash Storage (UFS), a Secure Digital (SD) device, and so on.

The storage device 100 includes at least a controller 120 and a non-volatile memory 140. Other components of the storage device 100 are not shown for brevity. The non-volatile memory 140 includes NAND flash memory devices. Each of the NAND flash memory devices includes one or more of the NAND flash dies 142a-142d, 144a-144d, 146a-146d, and 148a-148d, which are non-volatile memory capable of retaining data without power. Thus, the NAND flash memory devices refer to multiple NAND flash memory devices or dies within the non-volatile memory 140. The non-volatile memory 140 can therefore be referred to a memory array of dies as shown. Each of the dies 142a-142d, 144a-144d, 146a-146d, and 148a-148d has one or more planes. Each plane has multiple blocks, and each block has multiple pages.

The dies 142a-142d, 144a-144d, 146a-146d, and 148a-148d can be arranged in one or more memory communication channels connected to the controller 120. For example, dies 142a-d can be configured on one memory channel, dies 144a-d on another, and so on. While the 16 dies 142a-142d, 144a-144d, 146a-146d, and 148a-148d are shown in FIG. 1, the non-volatile memory 140 can include any suitable number of non-volatile memory dies that are arranged in one or more channels in communication with the controller 120.

While the dies 142a-142d, 144a-144d, 146a-146d, and 148a-148d are shown as an example implementation of the non-volatile memory 140, other examples of non-volatile memory technologies for implementing the non-volatile memory 140 include but are not limited to, Magnetic Random Access Memory (MRAM), Phase Change Memory (PCM), Ferro-Electric RAM (FeRAM), Resistive RAM (ReRAM), and so on that have locations for forming a superblock. The superblock management mechanisms described herein can be likewise implemented on memory systems using such memory technologies and other suitable memory technologies.

Examples of the controller 120 include but are not limited to, an SSD controller (e.g., a client SSD controller, a datacenter SSD controller, an enterprise SSD controller, and so on), a UFS controller, or an SD controller, and so on.

The controller 120 can combine raw data storage in the dies 142a-142d, 144a-144d, 146a-146d, and 148a-148d such that those dies 142a-142d, 144a-144d, 146a-146d, and 148a-148d function as a single storage. The controller 120 can include processors, microcontrollers, central processing units (CPUs), caches, buffers (e.g., buffers), error correction systems, data encryption systems, Flash Translation Layers (FTLs), mapping tables, a flash interface, and so on. Such functions can be implemented in hardware, software, and firmware or any combination thereof. In some arrangements, the software/firmware of the controller 120 can be stored in the non-volatile memory 140 or in any other suitable computer readable storage medium.

The controller 120 includes suitable processing and memory capabilities for executing functions described herein, among other functions. The controller 120 manages various features for the non-volatile memory 140, including but not limited to, I/O handling, reading, writing/programming, erasing, monitoring, logging, error handling, garbage collection, wear leveling, logical to physical address mapping, data protection (encryption/decryption), and the like. Thus, the controller 120 provides visibility to the dies 142a-142d, 144a-144d, 146a-146d, and 148a-148d.

In some arrangements, the controller 120 includes a superblock manager 130 configured to manage forming and maintaining the superblocks in the manner described herein. For example, the superblock manager 130 can form superblocks from the dies 142a-142d, 144a-144d, 146a-146d, and 148a-148d by selecting or reselecting block locations (e.g., those dies 142a-142d, 144a-144d, 146a-146d, and 148a-148d or planes thereof) that form the superblocks. The superblock manager 130 can be implemented using the processing and memory capabilities of the controller 120. The superblock manager 130 can be firmware or software or hardware running on the controller 120 and stored as codes in one or more suitable non-transitory memory devices. In some examples, the superblock manager 130 stores a list of blocks (e.g., a list of physical addresses of the blocks) for each superblock in a local memory and/or in the non-volatile memory 140.

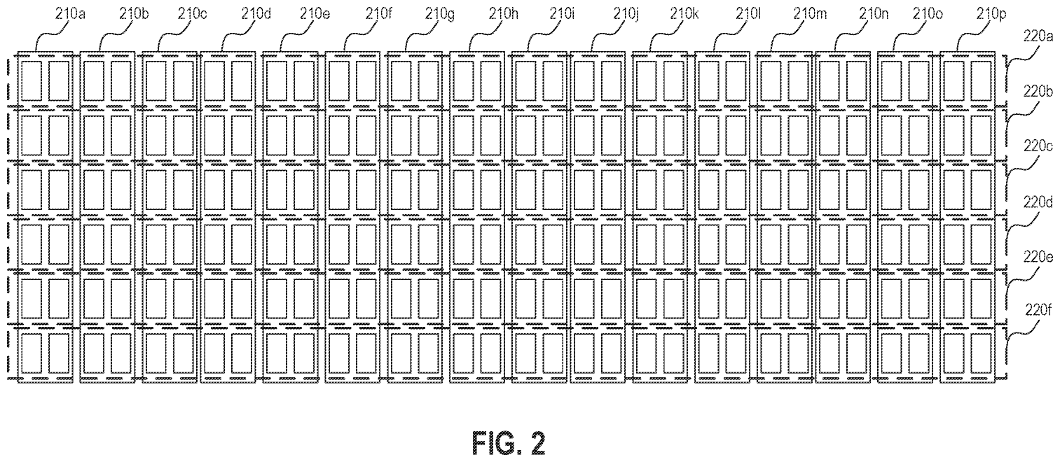

FIG. 2 is a schematic diagram illustrating superblock formation. Referring to FIGS. 1 and 2, a non-volatile memory of a storage device, such as the non-volatile memory 140 of the storage device 100, includes dies 210a, 210b, 210c, 210d, 210e, 210f, 210g, 210h, 210i, 210j, 210k, 210l, 210m, 210n, 210o, and 210p (collectively 210a-210p). Each of the 16 dies 210a-210p may be a die such as but not limited to, dies 142a-142d, 144a-144d, 146a-146d, and 148a-148d. Each of the dies 210a-210p may be a die such as but not limited to, the die 210.

Each of the dies 210a-210p includes 12 blocks, each of which is denoted as a rectangle and can be a block. The 12 blocks are shown for illustrative purposes. It should be understood that a die may have any number of blocks. Blocks arranged along a vertical column are located on the same plane. As shown, each of the dies 210a-210p has two planes, each plane includes six blocks.

As shown in FIG. 2, the superblock manager 130 may select a block from each of the planes to form a superblock. Thus, superblocks 220a, 220b, 220c, 220d, 220e, and 220f (collectively 220a-220f) are formed. Each of the superblocks 220a-220f is formed with a block from each plane of the dies 210a-210p. Other arrangements to generate superblocks can be likewise implemented based on superblock size and RAID requirement.

Each of the superblocks 220a-220f may have designated block(s) for RAID protection, referred to as RAID protection block(s). RAID protection data can be encoded using suitable ECC algorithms such as Reed-Solomon (RS) or Parity (XOR) encoding, allowing data in failed blocks to be recovered. In other arrangements, the superblocks 220a-220f may not have any block for RAID protection.

FIG. 2 shows an example of superblock formation. Superblocks formed using other methods can be likewise implemented.

The host 101 can send data to be written to a particular superblock using various mechanisms. The host 101 or the storage device 100 can flag the data as being aligned to a superblock. In some examples, the data to be written to a particular superblock has a logical block address (e.g., LBA) that is the same as a logical block address corresponding to the superblock or that is within a logical block address range corresponding to the superblock. In this case, the host 101 flags the data using the logical block address of the data. That is, the logical block address of the data services as an identifier that identifies a certain superblock. In some examples, the data to be written to a particular superblock is placed in the same submission queue (e.g., an NVMe submission Queue). In this case, the host 101 or the storage device 100 flags the data by placing the data into the submission queue corresponding to the superblock.

In some examples, the host 101 may send a stream of data to the storage device 100 via the host interface 110 to be written to the non-volatile memory 140. Data that belongs to the same stream is tagged with the same stream identifier (ID). The host 101 may run various tenants (e.g., software applications). Each tenant is assigned an identifier, e.g., a stream ID. Tenants from multiple hosts may store data to the same storage device 100. Data corresponding to each tenant or the stream ID associated therewith is written to the same superblock to reduce WA. In other words, a stream can be aligned to the size of a superblock, and the host 101 synchronizes a stream to the size of one superblock. For example, the storage device 100 can declare to the host 101 the size (e.g., the declared capacity) of each superblock (e.g., superblocks 220a-220f) formed in the non-volatile memory 140. The superblock manager 130 can keep track of the size, including the declared capacity and the reserved capacity, of each superblock. Synchronizing a stream to the declared capacity of one superblock block reduces WA given that when data is updated or erase, garbage collection with respect to one superblock instead of multiple superblocks is performed, thus extending the lifetime of the storage device 100.

Accordingly, some protocols allow writing data based on the declared capacity of a superblock. The host 101 allocates a stream (e.g., a stream ID) for a tenant, leaves some space or capacity remaining on the declared capacity of a superblock corresponding to the stream, and write additional data from the tenant to another superblock. This requires that the host 101 to have knowledge of the superblock size (e.g., the declared capacity) to align the data to the superblock size. The limit to which the host 101 can write data to a superblock is referred to as the declared capacity. The storage device 100 can declare the declared capacity of each superblock to the host 101 by sending suitable a message, log, or indication to the host 101. The host 101 itself also has knowledge of the data (e.g., logical addresses) that is on each superblock for the tenant.

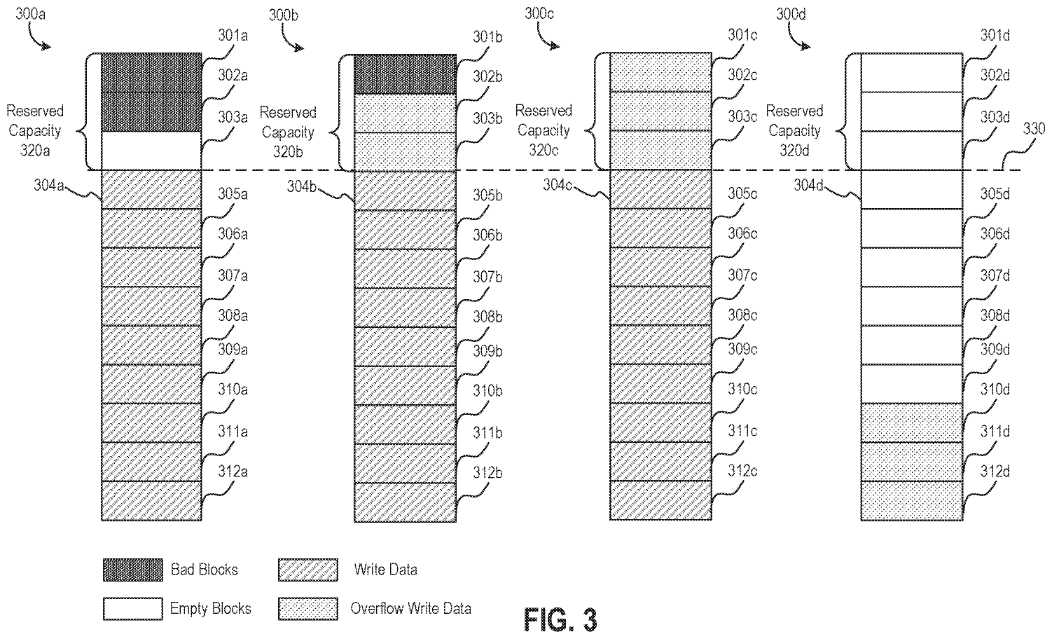

FIG. 3 is a schematic diagram illustrating write management for superblocks, according to various arrangements. Referring to FIGS. 1-3, FIG. 3 shows superblocks 300a, 300b, 300c, and 300d, each of which can be a superblock such as but not limited to, one of superblocks 220a-220f Each of the superblocks 300a, 300b, 300c, and 300d includes 12 blocks as shown. For example, superblock 300a includes constituent blocks 301a, 302a, 303a, 304a, 305a, 306a, 307a, 308a, 309a, 310a, 311a, and 312a. Superblock 300b includes constituent blocks 301b, 302b, 303b, 304b, 305b, 306b, 307b, 308b, 309b, 310b, 311b, and 312b. Superblock 300c includes constituent blocks 301c, 302c, 303c, 304c, 305c, 306c, 307c, 308c, 309c, 310c, 311c, and 312c. Superblock 300d includes constituent blocks 301d, 302d, 303d, 304d, 305d, 306d, 307d, 308d, 309d, 310d, 311d, and 312d. Each of those blocks can be a block such as but not limited to, a block of the dies 210a-210p. It should be understood that each of the superblocks 300a, 300b, 300c, and 300d may have any suitable number of blocks. Each of the superblocks 300a, 300b, 300c, and 300d can be formed using any suitable mechanism, including that described with respect to FIG. 2.

Write data that correspond to a first stream ID that is received from the host 101 is synchronized and written to the superblock 300a. Write data that correspond to a second stream ID that is received from the host 101 is synchronized and written to the superblock 300b. Write data that correspond to a third stream ID that is received from the host 101 is synchronized and written to the superblock 300c.

Each of the superblocks 300a, 300b, 300c, and 300d may include a reserved capacity at the discretion of the storage device 100. For example, the superblock 300a includes the reserved capacity 320a. The superblock 300b includes the reserved capacity 320b. The superblock 300c includes the reserved capacity 320c. The superblock 300d includes the reserved capacity 320d. The reserved capacity 320a, 320b, 320c, and 320d may be used to replace bad blocks (e.g., grown bad blocks) in the declared capacity (the blocks below the line 330) that develop during the lifetime of the superblocks 300a, 300b, 300c, and 300d. As shown, the superblock 300a has two grown bad blocks, and the reserved capacity 320a is used to replace those two bad blocks, shown as 301a and 302a. The superblock 300b has one grown bad block, and the reserved capacity 320b is used to replace that bad block, shown as block 301b. The superblocks 300c and 300d do not have any bad block. Although the bad blocks 301a, 302a, 301b grew bad in the declared capacity and not in the reserved capacity, those blocks are shown in FIG. 3 in the reserved capacities 320a and 320b to show that the reserved capacities 320a and 320b are used to replace those bad blocks to maintain the declared capacity 330. It is noted that two reserved blocks of the reserved capacity 320a that replace the bad blocks 301a and 302a are shown as any two of the blocks 304a-312a, and that the reserved block of the reserved capacity 320b that replace the bad block 301b is shown as any one of the blocks 304b-312b. Conventionally, a reserved block in the reserved capacity does not store any write data unless used to replace a block that grows bad. Thus, the reserved blocks correspond to additional memory space of a superblock that is initially unused until the superblock grows bad blocks.

Each of the superblocks 300a, 300b, 300c, and 300d has a declared capacity (e.g., 9 blocks) corresponding to the line 330. The storage device 100 (e.g., the controller 120) can declare the declared capacity in terms of a size (e.g., in MB) of each of the superblocks 300a, 300b, 300c, and 300d to the host 101 by sending suitable a message, log, or indication to the host 101. Although all of the superblocks 300a, 300b, 300c, and 300d have the same declared capacity as shown in FIG. 3, in other arrangements, two or more superblocks may have different synchronization boundaries or declared capacities.

The host 101 do not typically write over the declared capacity, given the knowledge of the declared capacity. However, due to the fact that the host 101 has no real-time knowledge of the bad blocks for each superblock, the host 101 may from time to time issues a write command instructing the storage device 100 to write data over the declared capacity.

In some examples, the controller 120 (e.g., a frontend of the controller 120 or an NVMe controller) accumulates all write commands received over a period of time and monitors the write commands and data sizes associated with those write commands. The controller 120 (e.g., the frontend) can monitor and log data sizes associated with the write commands for each superblock in response to receiving the commands and before processing the write commands to the backend. Conventionally, in response to determining that the write commands attempts to write data to a superblock that exceeds the declared capacity, the controller 120 (e.g., the frontend thereof) immediately responds to the host 101 with an error message. The overflow data is not written to the non-volatile memory 140. This may lead to the host 101 halting or evening killing the tenant corresponding to the superblock, which is an undesirable outcome for the host 101.

To address such issues, instead of rejecting the write command at the frontend, the controller 120 processes the write command in the backend and stores the overflow data to the non-volatile memory 140. The controller 120 reports a soft notification of the error condition to the host 101, such that the host 101 does not need to halt or kill the tenant associated with the write command. For example, the controller 120 can report the error condition via administrative messaging (e.g., at least one of an NVMe asynchronization event or log), instead of reporting a hard error message via a status response to the write command in real-time as conventionally performed. The administrative messaging differs from the status response in that the administrative messaging does not require any immediate host response. The log may be read by the host 101 every 12 or 24 hours, for example. Thus, the arrangements disclosed herein drastically reduce the burden on the host 101 to immediately remedy any write error which can be adequately addressed by the storage device 100 in the manner described herein. The arrangements herein also alleviate the storage device from frontend checking the amount written to a stream, which is more onerous than monitoring the data written in the backend.

In some arrangements, the overflow data is stored in the reserved capacity, e.g., in one or more reserved blocks of the reserved capacity that has not been used to replace bad block(s) in the declared capacity. As shown in FIG. 3, the overflow data for a stream ID corresponding to the superblock 300b exceeding the declared capacity is written to the reserved blocks 302b and 303b of the reserved capacity 320b of the superblock 300b, instead of being rejected. The overflow data for a stream ID corresponding to the superblock 300c exceeding the declared capacity is written to the reserved blocks 301c-303c of the reserved capacity 320c of the superblock 300c, instead of being rejected. Any overflow data attempted to be stored in the superblock 300a exceeding the declared capacity is to be written to the reserved block 303a of the reserved capacity 320a.

In some arrangements, the overflow data is written to another superblock. For example, any overflow data from a superblock can be written to the superblock 300d. The superblock 300d may be a dedicated superblock for overflow data, and may store overflow data from multiple superblocks (e.g., superblocks 300a, 300b, and 300c). Although garbage collection may be performed frequently on the superblock 300d, the overall and average lifetime of the group of superblocks 300a, 300b, 300c, and 300d can be improved.

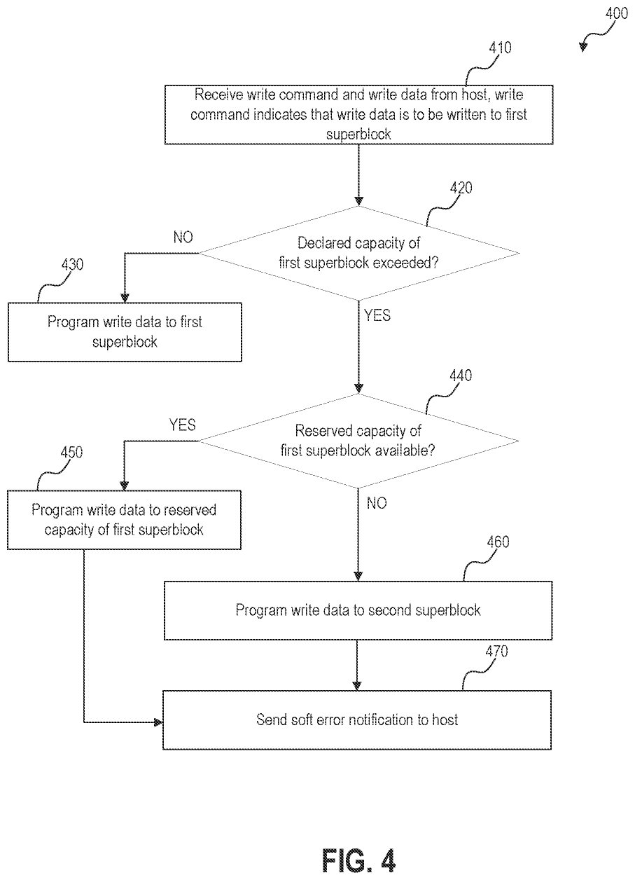

FIG. 4 is a method 400 for identifying and tolerating host errors in which the host 101 attempts to write data that exceeds the declared capacity of a superblock (e.g., a first superblock), according to various arrangements. Referring to FIGS. 1-4, the method 400 can be performed by the controller 120. In general, the method 400 is directed to allowing one or more additional write commands to be executed (e.g., storing the write data corresponding to those write commands) even if the declared capacity of the first superblock is exceeded. The overflow write data is stored in one or more reserved blocks of the first superblock and/or another superblock (e.g., a second superblock).

At 410, the controller 120 receives a write command and write data associated with the write command from the host 101. The write command indicates that the write data is to be written to the first superblock (e.g., superblock 300b). The write data may correspond to or from a same tenant, a same application running on the host 101, or a set of data that the host 101 groups together for placement, such that that the write data is to be written to the same superblock. In some examples, the write command may include or otherwise identify a stream ID or another suitable identifier such as the LBA that corresponds to a tenant of the host 101. The stream ID or identifier corresponds to the first superblock, as the first superblock was previously allocated for the stream ID or the identifier.

At 420, the controller 120 determines whether the declared capacity of the first superblock is exceeded assuming that the write data is stored to the first superblock. In other words, the controller 120 determines whether the first superblock lacks sufficient capacity to store the write data. In some examples, determining that the first superblock lacks sufficient capacity includes determining that a remainder of the declared capacity of the first superblock is less than a size of the write data. In some examples, determining that the first superblock lacks sufficient capacity includes determining that an entirety of the declared capacity of the first superblock is occupied by valid write data.

Some SSD protocols allow many NVMe submission queues to be written to each open superblock. In other words, data in various queues can be pushed to the same superblock. Conventionally, the frontend of the controller 120 identifies that the host 101 has filled the entire first superblock by monitoring every write command from every submission queue and count every write command that is mapped to each open superblock. This is typically performed before or while the write data is placed in the write buffers. This is a complicated and expensive implementation performed by the frontend of the controller 120 and can potentially delay the performance of the storage device 100. As described herein, conventionally, the controller 120 can detect that a certain write command may exceed the declared capacity of the first superblock through this monitoring and rejects the write command.

On the other hand, the arrangements disclosed herein allow the write command to proceed to the backend of the controller 120 that interface with the non-volatile memory 140. In other words, instead of rejecting a write command that seeks to write past the declared capacity, the write operation proceeds as the write data is sent to the write buffer and programmed to the non-volatile memory 140 (e.g., to the reserved capacity or the second superblock). This allows 420 to be performed using existing functions of the backend of the controller 120 to reduce complexity and delay, as no check may be required at the frontend. The backend of the controller 120 can transfer the write data from the write buffers to physical locations on the non-volatile memory 140. The backend of the controller 120 has knowledge of the physical locations of non-volatile memory 140 and implements a counter for data that is stored to a certain superblock, which allows for determination of the amount of data that is stored to a superblock.

In response to determining that the declared capacity of the first superblock is not exceeded (420:NO), the controller 120 programs the write data to the first superblock, at 430. On the other hand, in response to determining that the declared capacity of the first superblock is exceeded (420:YES), the controller 120 determines whether the reserved capacity of the first superblock is available, at 440. The reserved capacity includes one or more blocks configured to replace bad block(s) of the first superblock. In some examples, determining that the reserved capacity of the first superblock is available includes determining that a remainder of the reserved capacity of the first superblock is less than a size of the write data. In some examples, determining that the reserved capacity of the first superblock is available includes determining that a remainder of the reserved capacity of the first superblock is a non-zero value, meaning that the reserved capacity can store at least a portion if not all of the overflow data.

In response to determining that the reserved capacity of the first superblock is available (440:YES), the controller 120 programs the write data, now deemed to be overflow data, to the reserved capacity of the first superblock, at 450. As shown in FIG. 3, the overflow data exceeding the declared capacity (below the line 330) is stored in the reserved blocks 302b and 303b.

On the other hand, in response to determining that the reserved capacity of the first superblock is not available (440:NO), the controller 120 programs the write data, now deemed to be overflow data, to a second superblock (e.g., the superblock 300d). In some examples, the second superblock is a superblock dedicated to overflow data from multiple other superblocks (e.g., superblocks 300a, 300b, and 300c), such that overflow data corresponding to multiple stream IDs is stored in the second superblock. In other examples, the second superblock stores overflow data from only the first superblock, such that overflow data corresponding to one stream ID is stored in the second superblock.

In some examples, the entirety of the write data (e.g., the overflow data) is stored in the reserved capacity or the second superblock. In some examples, the overflow data is split into two portions, with a portion of the write data being programmed to the reserved capacity while another portion of the write data (which may not fit in the reserved capacity) being programmed to the second superblock.

In some examples, the write data is split into three portions, with a first portion being stored in the declared capacity of the first superblock. The overflow data includes a second portion and a third portion of the write data. The second portion of the write data is programmed to the reserved capacity while the third portion of the write data (which may not fit in the reserved capacity) is programmed to the second superblock.

At 470, the controller 120 sends a soft error notification to the host 101. For example, the controller 120 can report the error condition via administrative messaging (e.g., at least one of an NVMe asynchronization event or log). Block 470 can be performed any time after 420:YES, such that the soft error notification is asynchronous with the write command received at 410. In some examples, the soft error notification is sent to the host 101 in response to determining that the declared capacity of the first superblock is exceeded (420:YES). In other examples, the soft error notification is sent to the host 101 in response to or after programming the write data to the reserved capacity of the first superblock (e.g., at 450) or programming the write data to the second superblock (e.g., at 460).

In some examples, the controller 120 indicates to the host 101 via a message or log that a superblock is almost full. For example, in response to the backend of the controller 120 determining that the size of valid data in a superblock exceeds a reporting threshold, the controller 120 sends a message or log to the host 101 to allow the host 101 to act accordingly. The host 101 may choose to open a new superblock or use a new stream ID for subsequent data sent to the storage device 100 that correspond to the tenant. The reporting threshold can be a percentage (e.g., 70%, 80%, 90%, 95%) of the declared capacity of the superblock, in some examples. In some examples, the reporting threshold is a number less than the declared capacity.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout the previous description that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

It is understood that the specific order or hierarchy of steps in the processes disclosed is an example of illustrative approaches. Based upon design preferences, it is understood that the specific order or hierarchy of steps in the processes may be rearranged while remaining within the scope of the previous description. The accompanying method claims present elements of the various steps in a sample order, and are not meant to be limited to the specific order or hierarchy presented.

The previous description of the disclosed implementations is provided to enable any person skilled in the art to make or use the disclosed subject matter. Various modifications to these implementations will be readily apparent to those skilled in the art, and the generic principles defined herein may be applied to other implementations without departing from the spirit or scope of the previous description. Thus, the previous description is not intended to be limited to the implementations shown herein but is to be accorded the widest scope consistent with the principles and novel features disclosed herein.

The various examples illustrated and described are provided merely as examples to illustrate various features of the claims. However, features shown and described with respect to any given example are not necessarily limited to the associated example and may be used or combined with other examples that are shown and described. Further, the claims are not intended to be limited by any one example.

The foregoing method descriptions and the process flow diagrams are provided merely as illustrative examples and are not intended to require or imply that the steps of various examples must be performed in the order presented. As will be appreciated by one of skill in the art the order of steps in the foregoing examples may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the examples disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The hardware used to implement the various illustrative logics, logical blocks, modules, and circuits described in connection with the examples disclosed herein may be implemented or performed with a general purpose processor, a DSP, an ASIC, an FPGA or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In some examples, the functions described may be implemented in hardware, software, firmware, or any combination thereof. If implemented in software, the functions may be stored as one or more instructions or code on a non-transitory computer-readable storage medium or non-transitory processor-readable storage medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storages, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed examples is provided to enable any person skilled in the art to make or use the present disclosure. Various modifications to these examples will be readily apparent to those skilled in the art, and the generic principles defined herein may be applied to some examples without departing from the spirit or scope of the disclosure. Thus, the present disclosure is not intended to be limited to the examples shown herein but is to be accorded the widest scope consistent with the following claims and the principles and novel features disclosed herein.

What is claimed is:

1. A method, comprising:
receiving, by a storage device from a host, a write command and a write data, wherein the write command indicates that the write data is to be written to a first superblock of the storage device;
determining, by the storage device, that the first superblock lacks sufficient capacity to store the write data; and
in response to determining that the first superblock lacks the sufficient capacity to store the write data, programming, by the storage device, the write data to at least one of a reserved capacity of the first superblock or a second superblock.

2. The method of claim 1, wherein
the write command identifies a set of data that corresponds to a tenant of the host, an application of the host, or a data grouped by the host for placement.

3. The method of claim 1, wherein determining that the first superblock lacks the sufficient capacity comprises determining that a remainder of a declared capacity of the first superblock is less than a size of the write data.

4. The method of claim 1, wherein determining that the first superblock lacks the sufficient capacity comprises determining that an entirety of a declared capacity of the first superblock is occupied.

5. The method of claim 1, wherein the reserved capacity comprises one or more blocks configured to replace one or more bad blocks of the first superblock.

6. The method of claim 1, wherein
a portion of the write data is programmed to the reserved capacity; and
another portion of the write data is programmed to the second superblock.

7. The method of claim 1, wherein
a first portion of the write data is programmed to a remainder of the declared capacity of the first superblock;
a second portion of the write data is programmed to the reserved capacity; and
a third portion of the write data is programmed to the second superblock.

8. The method of claim 1, further comprising sending, by the storage device to the host, a soft error notification indicating that the first superblock lacks the sufficient capacity to store the write data.

9. The method of claim 1, wherein the first superblock is determined to lack the sufficient capacity to store the write data by a backend of the controller.

10. The method of claim 1, wherein programming the write data to the at least one of the reserved capacity of the first superblock or the second superblock comprises:
determining, by the controller, that the reserved capacity of the first superblock is available; and
in response to determining that the reserved capacity of the first superblock is available, storing the write data to the reserved capacity.

11. The method of claim 1, wherein programming the write data to the at least one of the reserved capacity of the first superblock or the second superblock comprises:
determining, by the controller, that the reserved capacity of the first superblock is not available; and
in response to determining that the reserved capacity of the first superblock is not available, storing the write data to the second superblock.

12. At least one non-transitory computer-readable medium comprising computer-readable instructions, such that, when executed, by a processor, causes the processor to:
receive from a host, a write command and a write data, wherein the write command indicates that the write data is to be written to a first superblock of the storage device;
determine that the first superblock lacks sufficient capacity to store the write data; and
in response to determining that the first superblock lacks the sufficient capacity to store the write data, program the write data to at least one of a reserved capacity of the first superblock or a second superblock.

13. The non-transitory computer-readable medium of claim 12, wherein
the write command identifies a set of data that corresponds to a tenant of the host, an application of the host, or a data grouped by the host for placement.

14. The non-transitory computer-readable medium of claim 12, wherein determining that the first superblock lacks the sufficient capacity comprises determining that a remainder of a declared capacity of the first superblock is less than a size of the write data.

15. The non-transitory computer-readable medium of claim 12, wherein determining that the first superblock lacks the sufficient capacity comprises determining that an entirety of a declared capacity of the first superblock is occupied.

16. The non-transitory computer-readable medium of claim 12, wherein the reserved capacity comprises one or more blocks configured to replace one or more bad blocks of the first superblock.

17. The non-transitory computer-readable medium of claim 12, wherein
a portion of the write data is programmed to the reserved capacity; and
another portion of the write data is programmed to the second superblock.

18. The non-transitory computer-readable medium of claim 12, wherein programming the write data to the at least one of the reserved capacity of the first superblock or the second superblock comprises:
determining, by the controller, that the reserved capacity of the first superblock is available; and
in response to determining that the reserved capacity of the first superblock is available, storing the write data to the reserved capacity.

19. The non-transitory computer-readable medium of claim 12, wherein programming the write data to the at least one of the reserved capacity of the first superblock or the second superblock comprises:
determining, by the controller, that the reserved capacity of the first superblock is not available; and
in response to determining that the reserved capacity of the first superblock is not available, storing the write data to the second superblock.

20. A storage device, comprising:
a non-volatile storage comprising a first superblock and a second superblock; and
a controller configured to:
receive from a host, a write command and a write data, wherein the write command indicates that the write data is to be written to a first superblock of the storage device;
determine that the first superblock lacks sufficient capacity to store the write data; and
in response to determining that the first superblock lacks the sufficient capacity to store the write data, program the write data to at least one of a reserved capacity of the first superblock or a second superblock.
